(19) United States
(12) Patent Application Publication
(10) Pub. No.: US 2012/0073258 A1
(43) Pub. Date: Mar. 29, 2012

(54) EDGING AND TRIMMER BLADE

(76) Inventor: Mark Stanley, Livermore, CA (US)

(21) Appl. No.: 13/250,884

(22) Filed: Sep. 30, 2011

Related U.S. Application Data
(62) Division of application No. 12/402,144, filed on Mar. 11, 2009, now abandoned.

(51) Int. Cl. A01D 34/52

(52) U.S. Cl. 56/295

(57) ABSTRACT

An edging and trimmer cutting device or blade designed for improved durability, performance, and safety. The blade is molded of flexible material composed of synthetic engineered urethane polymer, a polyamide or other resilient mesh bonded to or embedded in the blade for a cutting material to provide a cutting edge, and a metal or other high-durometer support member embedded in the blade. The size of the mesh may be coextensive with that of the blade and the fabric is positioned to intersect the cutting edges of the blade.

### CROSS REFERENCE TO RELATED APPLICATION

This application is a divisional application, claiming the priority of co-pending U.S. application Ser. No. 12/402,144, filed Mar. 11, 2009.

### DESCRIPTION

1. Technical Field

This invention relates to an improved mower blade that has a layer of high strength fabric embedded in the blade. The blade comprises a synthetic engineered urethane polymer, as well as a centrally positioned metallic bar encased in the blade. The outer portions of each blade has a cutting edge that intersects the fabric. Also included in the invention are string trimmers where the cutting string is made of polymer material.

2. Background Art

Conventional lawn mowers, edgers, and trimmers used by homeowners are usually rotary and use gasoline or electric motors. These devices are also popular with commercial and industrial mowing operations.

The term “rotary” refers to a mower in which the shaft extends vertically downward from the housing and upon which the blade is mounted so that it rotates in a plane parallel to the ground. This type of mower is popular because it is simple to operate, inexpensive to build, and performs a highly satisfactory job of cutting grass and weeds. The prior art as disclosed in U.S. Pat. No. 3,545,189 comprises a flexible blade assembly in which outer extremities of the assembly are made of high tensile fabric bonded with a rubber-like material and wherein the hub area is provided with a pair of rigid metal clamping plates clamped to the upper and lower sides of the flexible portion of the blade assembly by rivets or other suitable means.

U.S. Pat. No. 3,911,652 discloses a completely molded blade assembly wherein layers of fabric and rubber-like bonding layers are alternately laid adjacent to each other at opposite sides of a carburized steel member of substantial rigidity. The rigid metal layer was encapsulated in the fabric and rubber-like material of the assembly.

### DISCLOSURE OF THE INVENTION

It is an object of this invention to provide for mowing, edging, and trimming blades and trimming strings comprised of synthetic engineered urethane polymer structural construction of mowing, edging, and trimming blades and strings to provide increased safety by allowing the blades to temporarily flex without breaking when they strike obstructions and then flex back into alignment afterwards. Further, this construction substantially reduces wear to the balde or string from abrasion and thus greatly extends the useful life of such cutting blades and strings. A preferred embodiment of the blades also include a metal or other high-durometer support member and a cutting mesh embedded in the polymer blade. The blades may be additionally comprise an assembly of the above described components further having an opening for securing the blade assembly to the vertical shaft of a mower, edger, or trimmer with the shaft and securing device contracting the metal or high-durometer support member.

It is an object of the present invention to provide an improved safety blade wherein a metal member is bonded to a synthetic engineered urethane polymer. The metal, or other high durometer support member may be embedded in or bonded to all or a portion of the length of the blade. The above described support member assists in securing the blade assembly to the vertical shaft of a mower, edger, or trimmer.

A polyamide or similarly composed mesh bonded to or embedded in the synthetic engineered urethane polymer provides a softer and more resilient cutting surface as compared to the usual rigid metal blade. The cutting mesh may be bonded to or embedded in the entire length of the blade, or may be located at various locations along the blade, such as the cutting edges, which will enhance the blade's strength, durability, and cutting effectiveness. The above-described mesh will wear at a slower rate than the surrounding materials, thus allowing the mesh to act as the cutting edge of the blade.

Although a preferred embodiment of the invention includes a metal, or other high durometer support member, and the polyamide or similarly composed mesh bonded to or embedded in the synthetic engineered polymer, another embodiment of the invention is an improved safety blade made entirely out of the synthetic engineered urethane polymer. Such a blade is novel, useful, and would constitute an improvement over existing blades that are not similarly composed.

Another object of the invention is to provide a blade that provides safety for the operator of the device, as well as safety for the engine and shaft of the device.

The foregoing and other features and advantages of the present invention will become apparent from the following description and accompanying drawings.

### BRIEF DESCRIPTION OF THE DRAWINGS

FIG. 1 is a perspective view of a mower blade showing the separated elements of the metal or other high durometer support member, the synthetic engineered urethane polymer, and the polyamide or similarly composed mesh.

FIG. 2 is a perspective view of the portion of the mower blade wherein the metal or other high durometer support member and the polyamide or similarly composed mesh is bonded to or embedded in the synthetic engineered urethane polymer.

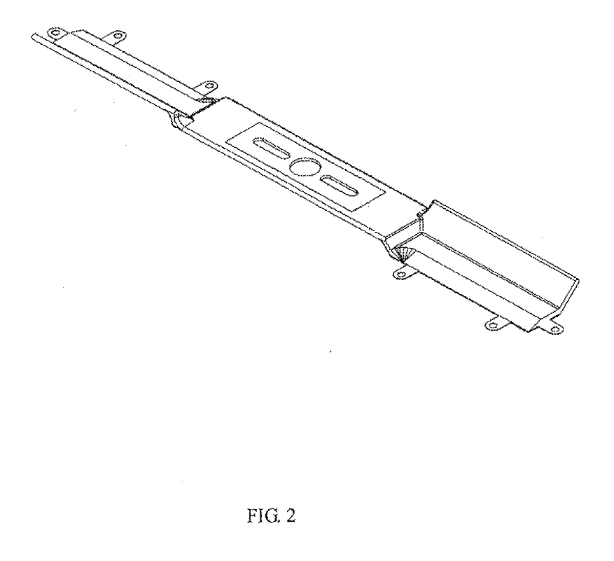

FIG. 3 is an exploded perspective view of the three pronged edger blade showing the separated elements of the metal or other high durometer support member, the synthetic engineered urethane polymer, and the polyamide or similarly composed mesh.

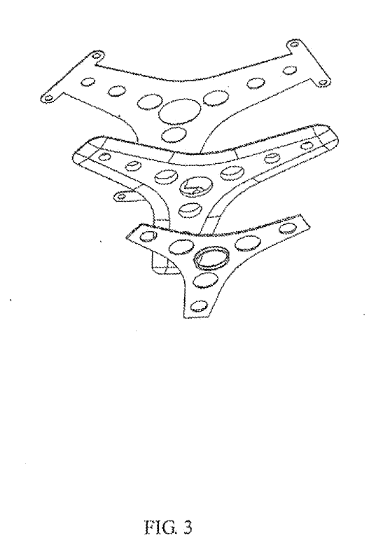

FIG. 4 is an perspective view of a three pronged edger blade wherein the metal or other high durometer support member, and the polyamide or similarly composed mesh is bonded to or embedded in the synthetic engineered urethane polymer.

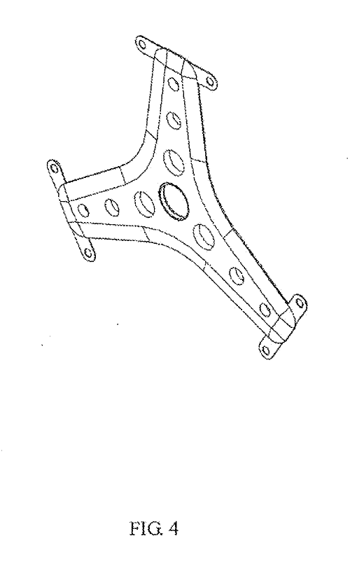

FIG. 5 is an exploded perspective view of the trimmer blade showing the separated elements of the metal or other high durometer support member, the synthetic engineered urethane polymer, and the polyamide or similarly composed mesh.

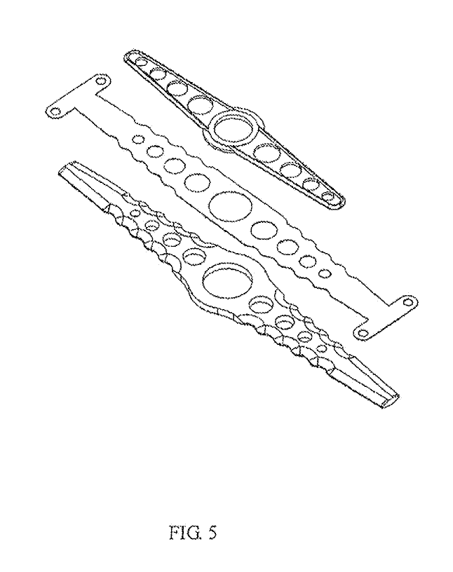

FIG. 6 is a perspective view of the portion of the trimmer blade wherein the metal or other high durometer support member, and the polyamide or similarly composed mesh is bonded to or embedded in the synthetic engineered urethane polymer.

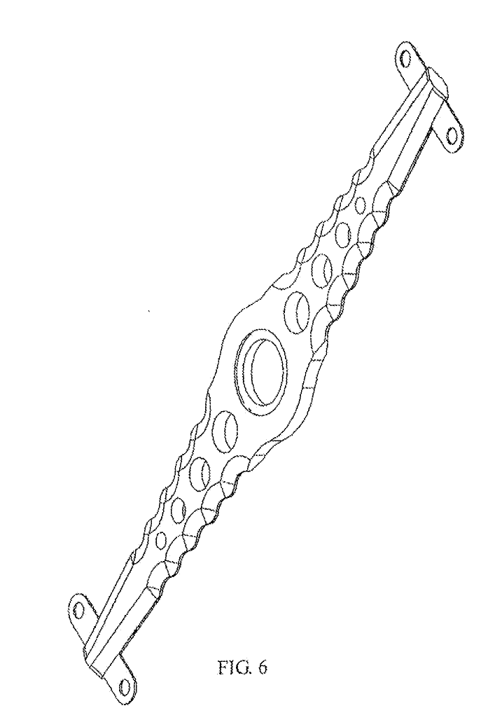

### DESCRIPTION OF EMBODIMENTS OF THE INVENTION

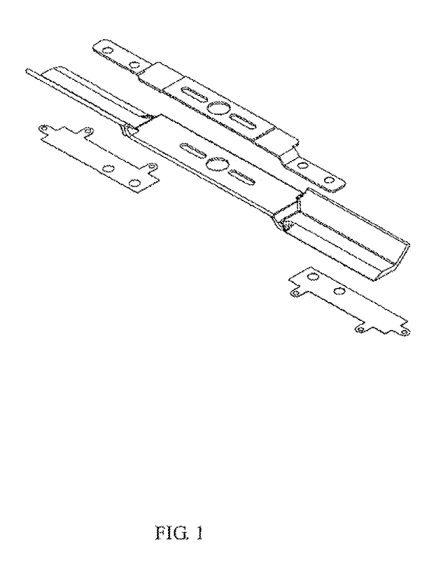

A mower blade embodiment of this invention is generally indicated in FIG. 1. It is designed for horizontal rotation about the center of a bolt opening at the blade's center for receiving a bolt to attach the blade to a drive shaft of a mower. The blade FIG. 1 is elongated and is provided at each end with cutting surfaces having leading edges that are disposed on the forward side of the blade.

To each lift wing FIG. 1 is applied a layer of polyurethane mesh, or similar cutting material. Suitable materials include polyurethanes. Suitable materials will preferably have a Durometer hardness of approximately 55-100 and preferably approximately 60-85 measured on the Shore A scale and with exhibit less than 70 mg and preferably less than 45 mg loss per thousand cycles of Taber abrasion testing using the H18 test at 1,000 gms load (ASTM C501).

The polyurethane layer should be of such a size as to cover the uplifted area of both lift wings, and the horizontal surface areas of the blade that are adjacent to the lift wings. This may be accomplished by having a single piece of polyurethane shaped for each lift wing that is covered. The single layer may be cut to cover a lift wing with allowance to cover a portion of the adjacent flat surfaces of the blade. A mower blade, having two lift wings, may thus require just two layers of protective material, one for each lift wing.

An alternative to applying the polyurethane layer to only the wing portion of the blade is to bond or embed the polyurethane layer to the entire length of the blade. This configuration may allow for ease in manufacture, and thus lower production costs.

Preferably, the polyurethane layer should be approximately one-eighth to one-quarter inch in thickness. The leading surface of each layer is cut at an acute angle with reference to the horizontal surface of the blade. Each leading surface of the layer on each lift wing provides an increase in the lift generated by the blade to improve the cutting action of the blade.

The bonding of the polyurethane layer of the metal to the blade can be accomplished by using a cyanoacrylate-type of adhesive, together with an appropriate primer such as those containing tetrahydrofuran. The polyurethane surface of layer to be bonded is first coated with the primer. The adhesive is then applied to the metal blade. The two surfaces are quickly joined together and clamped. They are then allowed to cure in air at normal air temperatures. This bonding process results in an extremely tight and secure bond that will withstand severe shock and abrasion. Other protective materials of similar hardness can be affixed to a blade over the lift wings.

The angled leading, or forward, surface of a layer can have its leading edge cut blunt to flatten the forward edge where it is adhered to the flat horizontal area surface.

Polymer can also be used to make string trimmers.

Current string trimmers or weed trimmers typically have a cutting head in which line or string is wound upon a reel or spool, with the spool being situated inside an outer shell of the cutting head. There is a free end of the line projecting out through this shell, and that is what contacts the grass or weeds for cutting. The string trimmer may be gasoline powered, or electric (AC or battery), with a motor drive that spins the cutting head. The reel or spool typically has an annular bay, i.e., a recess in which the string is wound, and there may be two or more bays on the spool, with a cutting string reposed in each bay. The action of cutting grass and weeds abrades and wears out the string, and so the string has to be continually let out from the spool. When all the string has been used up, then the user has to rewind more string onto the spool, and that can be a difficult, tedious process. The line that is used may be too stiff to be handled easily, and because the dimensions of the bays on the spool are usually smaller than the size of the user's fingers, it is difficult to hold the string and secure it to the reel to start rewinding process. Also, this type of trimmer is limited to using strings of round cross section or profile, and thus precludes the use of strings of other profiles that may actually be more suited to cutting some types of vegetation.

Accordingly, it is an object of this invention to provide a trimmer string that is simple to install and use, and which avoids the drawbacks of the prior art.

It is another object to provide a trimmer string arrangement that can be employed with a large variety of existing string trimmers.

Another object of the invention is to provide a filament for a line trimmer composed in whole or in part of a synthetic engineered urethane polymer. Line trimmers have become common in the industry, but the use of synthetic engineered urethane polymer as a filament is unknown and novel. Filaments made of this material have shown that they provide exceptional cutting ability, safety, and durability.

It is further object to provide a replacement trimmer string arrangement that comprises a cutting string containing synthetic engineered urethane polymer which can be made in a wide variety of profiles and cross sections. Cutting string containing synthetic engineered urethane polymer has advantages over existing cutting string materials in the areas of durability, safety, and ease of use.

According to an aspect of this invention, a string is provided for a string trimmer in which a spool (or the equivalent in the case of a fixed string trimmer) that may have one or several annular bays is provided to hold a length of cutting string. The cutting string may have one end affixed at a first end of a spool or other device for holding the string, and the string extends out that one end, then after forming a loop or bight, passes through a guide tunnel and continues radially outward, so that a free end that projects from the cutting head when the string arrangement is installed in the cutting head.

The various methods for manufacturing the described invention include injection molding, cast molding, open cast molding and compression molding.

In injection molding, plastic granules are heated and “injected” under pressure into metal molds, where the molten plastic hardens into a designated shape. The mold then opens and the newly formed part is removed and inspected, ready for shipment or secondary manufacturing operations. Injection molding is an extremely versatile and popular form of molding. Other processes include extrusion, thermoforming, and blow molding. Injection molding becomes insert molding when a specifically designed insert (typically of metal) is nested in the mold before the molten plastic injected. The plastic hardens around the insert and the resulting part is a combination of plastic and insert. A simple example would be certain scissors in which metal blades are inserted into the mold, and plastic handles are molded around the blades.

Compression molding is technique used to form thermoplastic and thermoset materials into simple geometric shapes by placing a mold on a heated platen. The material is then placed in the mold. Thermoset materials may start to cure as soon as they are exposed to heat resulting in no heat up time before compression. The next step is to compress the material in between the heated platens. For thermoset materials, the material is heated a sufficient amount of time for the material to solidify or cure. The platens are then opened and the sample removed. Our thermoset material comes in the form of layers of sheet molding compound.

Compacting sand or a similar material around the shape of a pattern can make cast moldings. Patterns can be made out of a variety of materials, including wood, metal and plastics. A parting agent can be used on a pattern to allow easy removal after the mold is made. Pattern types include one piece, split, and match plate. The design of the patterns should include consideration of shrinkage, and a slight taper should be added to the sides of the patterns to assist in the removal. Molds using wax and foam are also contemplated.

The foregoing and other features and advantages of the present invention will become more apparent form the following description and accompanying drawings.

Although this invention has been shown and described with respect to detailed embodiments thereof, it will be understood by those skilled in the art that various changes in form and detail thereof may be made without departing from the spirit and scope of the claimed invention.

We claim:

1. A lawn trimmer blade assembly, comprising:
a. A blade comprising:
i. A generally elongated, flat shape having:
1. two distal ends;
2. a midpoint between the two ends;
3. generally flat top and bottom sides; and
4. two edges, located along the sides of the blade;
ii. The blade composed of flexible, elastomeric material having sufficient rigidity to be self supporting; and
iii. an opening at the midpoint between the two ends of the blade to facilitate coupling to a rotating member of a lawn trimmer device.

2. The lawn trimmer blade assembly of claim 1, further comprising a mesh substrate embedded in the elastomeric material to provide a cutting edge.

3. The lawn trimmer blade assembly of claim 1, wherein the opening at the midpoint between the two ends of the blade is a round hole in the blade.

4. The lawn trimmer blade assembly of claim 1, wherein the flexible elastomeric material is composed of synthetic engineered urethane polymer.

5. The lawn trimmer blade assembly of claim 2, wherein the mesh substrate is composed of a polyamide material.

6. The lawn trimmer blade assembly of claim 2, wherein the mesh substrate is composed of polyester.

7. The lawn trimmer blade assembly of claim 2, wherein the mesh substrate is composed of fiberglass.

8. The lawn trimmer blade assembly of claim 2, wherein the mesh substrate is composed of synthetic engineered urethane polymer.

9. The lawn trimmer blade assembly of claim 2, wherein the edges of the blade are undulated.
